(19) United States
(12) Patent Application Publication
(10) Pub. No.: US 2001/0053270 A1
(43) Pub. Date: Dec. 20, 2001

(54) Glass-ceramic fiber lasers and amplifiers

(76) Inventors: Nicholas F. Borrelli, Elmira, NY (US); Bryce N. Samson, Horseheads, NY (US); Paul A. Tick, Corning, NY (US)

Correspondence Address: Svetlana Short, Corning Incorporated, SP-TI-3-1, Corning, NY, 14831, US

(21) Appl. No.: 09/802,791

(22) Filed: Mar. 8, 2001

Related U.S. Application Data
(60) Provisional application No. 60/202,454, filed on May 6, 2000.

(51) Int. Cl. G02B 6/16

(52) U.S. Cl. 385/123; 385/142

(57) ABSTRACT

A glass-ceramic rare earth doped fiber comprises a plurality of crystallites, wherein at least 90% of the rare earth dopant is situated within said crystallites. The stimulated emission and absorption line shapes of the rare earth doped glass-ceramic fiber is narrower than that stimulated emission and absorption line shapes of the precursor rare earth doped glass. This is indication of the reduction in the inhomogenous broadening of glass-ceramic fibers compared to glass fibers. An embodiment of an optical amplifier includes: an input port; a length of glass-ceramic rare earth doped fiber, the glass-ceramic fiber being operatively coupled to the input port and including a plurality of crystallites; at least one optical pump coupled to this glass-ceramic fiber; an output port providing an amplified optical signal; and at least one optical component situated between the input port and the output port.

### CROSS REFERENCE TO RELATED APPLICATION

This application claims the benefit of U.S. Provisional Patent Application No. 60/202,454, filed May 6, 2000.

### BACKGROUND OF THE INVENTION

1. Field of the Invention

This invention relates to glass-ceramic fibers, glass-ceramic lasers and glass-ceramic amplifiers. More particularly it relates to the fiber lasers and amplifiers with reduced excited state absorption.

2. Technical Background

Optical amplifiers and lasers increase the amplitude of optical wave through a process known as stimulated emission in which a photon, supplied to the input signal, induces higher energy level electrons within an optical material to undergo a transition to lower energy level. In the process, the material emits a photon in the same frequency, direction and polarization as the initial photon. These two photons can, in turn, serve to stimulate the emission of two additional photons, and so forth. The result is light amplification. Similar emission occurs when the forth in energy is nearly equal to the atomic transition energy difference. For this reason, the process produces amplification in one or more bands of frequencies determined by the atomic line width. The Photonics industry typically uses amplifiers that utilize optical glass fiber for optical communications applications. Such fibers are usually made of a silica glass combined with a rare earth dopant such as Erbium. The operating wavelengths of the optical amplifiers and lasers are dictated by atomic properties of the host and the rare earth dopant. The phenomenal growth's indication technology and information technology has fueled considerable interest in finding new optical fiber materials will increase signal channel been these and allow engineers to exploit new frequency bands.

To date there are no efficient Nd doped glass lasers or amplifiers operating at wavelengths of about 1300 nm. This is because the lasing and amplification in this wavelength range is provided by ⁴F_{3/2} to 4I11_{/2} electron transition which has a small transition cross-section and additionally because the presence of excited state absorption (ESA) from the ⁴F_{3/2} level to the 4G_{7/2} level severely limits the slope efficiency and available gain bandwidth.

It is known that a relatively efficient Neodymium doped crystal laser can operate in wavelengths range of 1320 to 1380 nm, depending on the crystal host. However, the difficulty and expense of growing crystals, coupled with the fact that making waveguides in this materials is almost impossible, is a severe drawback. Because of this, in lasers and optical amplifiers, the glass host is preferred to the crystal host.

Glass-ceramic materials are known. They are a 2-phase system, comprising crystals controllably grown within the host glass by application of an appropriate heat treatment. The optical properties of glass ceramic materials have been studied for a number of years with a particular emphasis in improving the transparency of these materials. This is achieved by careful control of both the crystal size and crystal composition induced by ceramming process. When the crystals size is smaller than the wavelengths of light (1500 nm) and when the refractive index of the crystals is similar to that of the surrounding glass, it is possible to keep losses due to light scatter to a minimum, particularly in the infrared part of the spectrum. It has been demonstrated that such glass-ceramic materials can be produced in the form of single mode glass-ceramic fibers and that such fibers have very low levels of scattering losses when the appropriate heat treatment is applied. This fiber is made by double crucible technique from glass is his compositions containing 30SᵢO₂-15AlO_{3/2}-29CdF₂-17PbF₂-4YF₃. X-ray and STEM (transmission electron microscopy) data on bulk samples indicate that in this particular glass-ceramic material the crystal phrase is comprised of 29CdF₂, PbF₂, YF₃. The crystals inbedded in the glass are very small, was diameters of about 10 nm or less and comprise about 10 percent of the overall glass ceramic material. This glass-ceramic material is very transparent in the infrared wavelength region. This glass-ceramic material is described in a to U.S. Pat. No. 5,483,628, which is incorporated by reference herein.

### SUMMARY OF THE INVENTION

According to one aspect of the present invention a glass-ceramic rare earth doped fiber comprises a plurality of crystallites, wherein at least 90% of the rare earth dopant is situated within said crystallites. According to an embodiment of the present invention at least 99% of the rare earth dopant is situated within the crystallites and the stimulated emission and absorption line shapes of the rare earth doped glass-ceramic fiber is narrower than that stimulated emission profile of the precursor rare earth doped glass.

According to one embodiment an optical amplifier includes: an input port; a length of glass-ceramic rare earth doped fiber, the glass-ceramic fiber operatively coupled to the input port and including a plurality of crystallites; at least one optical pump coupled to this glass-ceramic fiber; an output port providing an amplified optical signal; and at least one optical component situated between the input port and the output port.

For a more complete understanding of the invention, its objects and advantages refer to the following specification and to the accompanying drawings. Additional features and advantages of the invention are set forth in the detailed description, which follows.

It should be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various features and embodiments of the invention, and together with the description serve to explain the principles and operation of the invention.

### BRIEF DESCRIPTION OF THE DRAWINGS

FIG. 1 illustrates schematically a glass ceramic fiber amplifier.

FIG. 2 illustrates the fluorescence spectrum and the lasing spectrum of the Nd doped glass fiber at 1050 nm.

FIG. 3 illustrates the fluorescence and lasing spectrum of a section of the Nd doped glass-ceramic fiber at 1050 nm.

FIG. 4 illustrates that the absorption spectrum of the Nd doped glass fiber is broader than the absorption spectrum of the Nd doped glass-ceramic fiber.

FIG. 5 illustrates the fluorescence spectrum and the gain spectrum of the Nd doped glass fiber at 1350 nm.

FIG. 6 illustrates fluorescence and the gain spectrum of Nd doped glass-ceramic fiber at 1350 nm.

### DETAILED DESCRIPTION OF THE PREFERRED EMBODIMENTS

As stated above, a relatively efficient Neodymium doped crystal laser can operate in wavelengths range of 1320 to 1380 nm, depending on the crystal host. This is due to the narrow emission and absorption line shape of the Neodymium doped crystals, which results from the decrease in inhomogeneous broadening. However, such crystals expensive and difficult to grow. Therefore, applicants decided to utilize glass-ceramic in the optical fiber amplifiers and lasers because glass-ceramic materials exhibit spectral characteristics of rare earth dopant crystal and have the flexibility of formation found in glass.

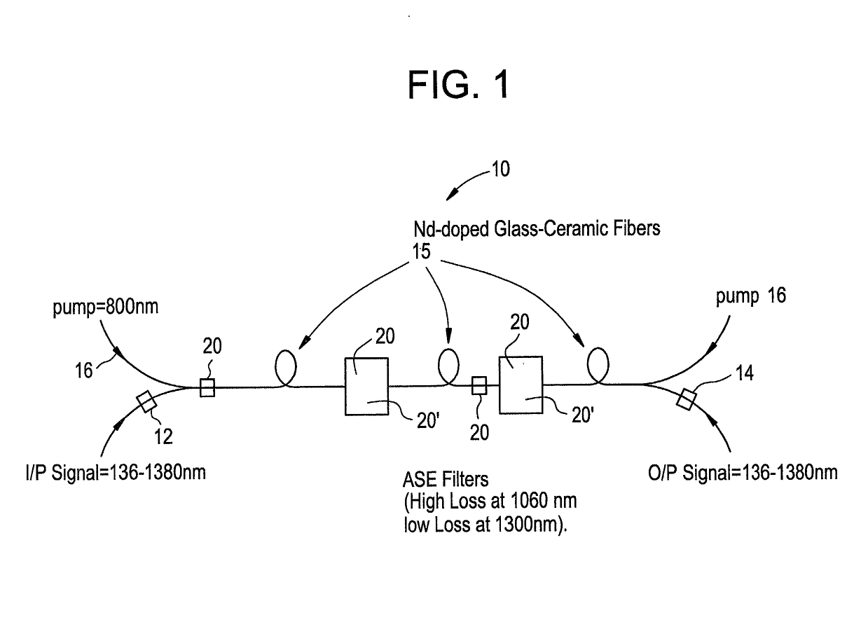

Optical glass-ceramic fibers utilized in the optical amplifier 10, illustrated in FIG. 1, where made by double crucible method and were doped with 500 ppm NdF₃. The core diameter of the exemplary Nd doped glass-ceramic fiber is about five microns. Approximately 5 meter long lengths of the Nd doped glass fibers were heat treated with exemplary ceramming schedules of 450° C. for about 30 minutes. The resultant glass-ceramic fibers are easy to handle and do not significantly deteriorate after ceramming process. The glass ceramic material has about 10 percent volume crystal with cross sections of about 100 nm and, preferably, 10 nm less. Other materials such as a Praseodymium (Pr⁺³), Thulium (Tm⁺³) or Dysprosium (Dy⁺³), for example, may also be used as dopants when making glass-ceramic optical fibers. The doping level is greater than 100 ppm and preferably greater than 200 ppm. As stated above, in this embodiment the doping level is about 500 ppm.

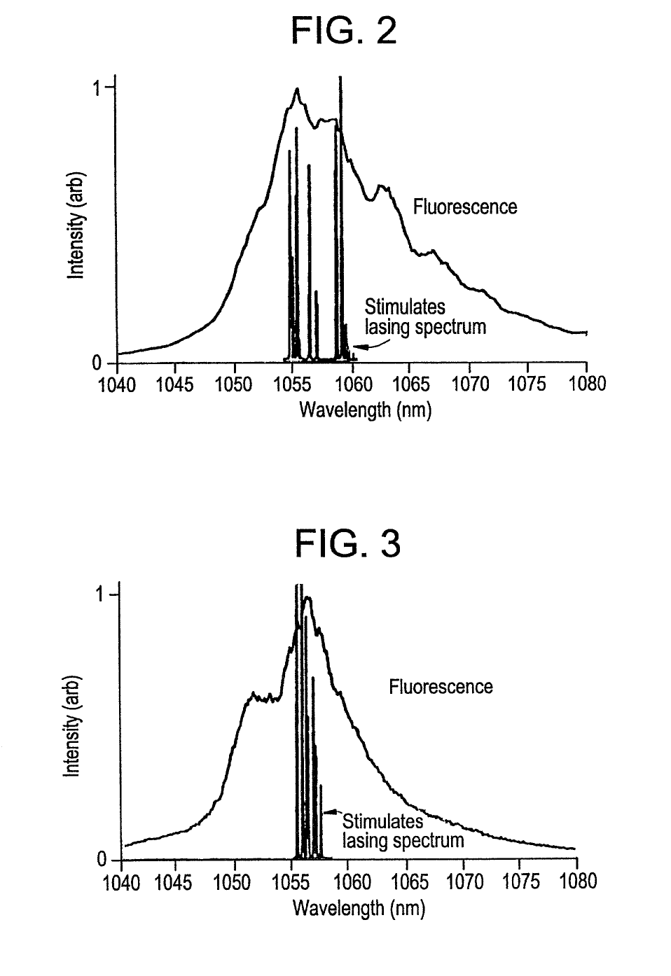

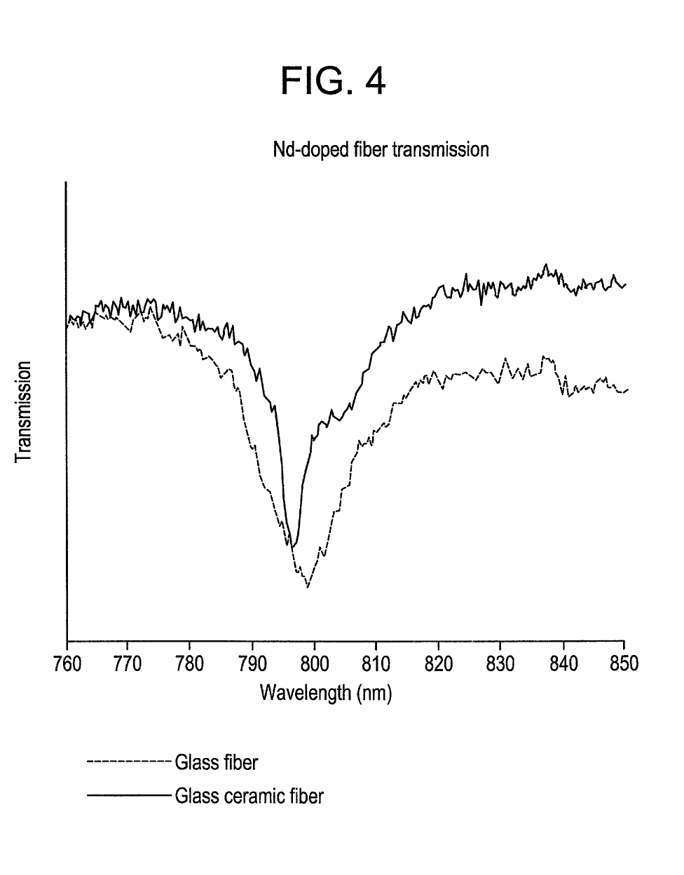

The fluorescence spectrum around 1050 nm (⁴F_{3/2}-⁴I_{11/12} transition) for the Nd doped glass fiber utilized in manufacturing Nd doped glass-ceramic fiber is shown in FIG. 2. The composition of the host glass is described in Table 3 of the U.S. Pat. No. 5,483,628, which is incorporated by reference herein. FIG. 2 also shows the laser emission spectrum of this Nd doped glass fiber when the fiber was pumped by the 800 nm Ti:sapphire laser. This glass fiber was used as the precursor for making a glass-ceramic fiber by forming the microscopic crystals (crystallites) there in by the ceramming process. The fluorescence and stimulated emission spectrum for a section of the glass-ceramic fiber is shown in FIG. 3. More specifically, FIG. 3 illustrates that ceramming process had drastically altered the spectroscopic properties of the Nd-doped fiber, which resulted in significant narrowing of both the fluorescence and the laser emission spectrums in the glass-ceramic fiber. (It is noted that the fluorescence spectrum is similar, and behaves similarly to stimulated emission spectrum). This narrowing of the spectra is due to the rare earth ions migrating into the microcrystals, which advantageously results in the subsequent reduction in the contribution to the fluorescence line shape from inhomogenous broadening. Thus, it is preferred that at least 90%, and preferably at least 95% and most preferably 99% of the rare earth dopant (ions/cm³) are located in the micocrystals (crystallites). The same effect is seen in FIG. 4, where the 800 nm ground state absorption spectrum is considerably narrower in the glass-ceramic fiber compared with the glass fiber. Again illustrating the reduced inhomogenous broadening in glass ceramic fibers with high rare earth partitioning.

In the next experiment, similar lengths of fiber were investigated as fiber amplifiers operating on the ⁴F_{3/2}-⁴I_{13/2} transition at around 1300 nm. The amount of gain from this transition is relatively low, partly due to the unfavorable branching ratio and the tendency for amplified spontaneous emission (ASE) at 1050 nm to clamp the available gain. The other factor is the presence of excited state absorption (ESA) from the ⁴F_{3/2} to ⁴G_{7/2} which peaks on the short wavelength side of the 1300 nm fluorescence spectrum and tends to shift the gain spectrum with respect to the emission. Both the wavelength and strength of the ESA are strongly host dependent; hence we might expect significant changes in the 1300 nm-gain spectrum of glass and glass ceramic fibers.

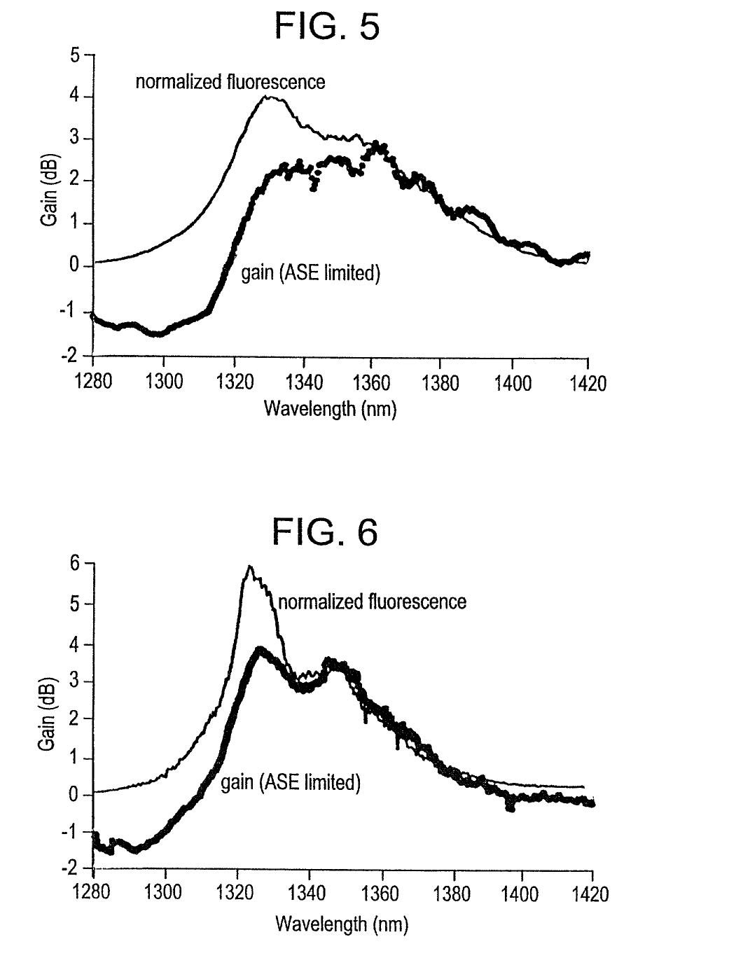

The measured fluorescence and single pass gain spectra for the glass and glass ceramic fibers are shown in FIGS. 5 and 6 respectively. As in the case of the 1050 nm fluorescence, we see a narrowing of the fluorescence spectrum in the glass-ceramic fiber coupled with a significant change in the measured small signal gain spectrum. In particular, the peak gain increases in magnitude (˜1 dB increase) and shifts to shorter wavelength (20 nm shift in peak wavelength) upon heat treatment, indicating a reduction and/or shifting of the ESA spectrum with respect to the emission. In both cases the available gain on this transition is limited by the ASE present at 1050 nm and any high gain amplifier would require suitable ASE filtering. These two experimental results are evidence of the strong partitioning of the Nd³⁺ ions into the crystal. Once in the crystal environment, the reduced inhomogenous broadening, an effect that is inherently large in glass fibers. In these cases, a suitable glass ceramic device would be an improvement over a glass matrix.

As stated above, the examples of a Nd-doped glass ceramic fiber amplifier 10 is illustrated schematically in FIG. 1, and includes an input port 12 providing an in-coming signal, an output port 14 providing an out-going amplified signal, at least one glass-ceramic rare earth doped fiber coil 15, an optical pump 16 coupled to the coil 15 and other optical components 20. For example, a multi-stage glass-ceramic fiber amplifier may include multiple fiber coils separated by ASE filters 20′. Other optical components 20 may be filters, optical attenuators, multiplexers, demultiplexers and isolators.

Accordingly, it will be apparent to those skilled in the art that various modifications and adaptations can be made to the present invention without departing from the spirit and scope of the invention. It is intended that the present invention covers the modifications and adaptations of this invention as defined by the appended claims and their equivalents.

What is claimed is:

1. A glass-ceramic rare earth doped fiber, said glass-ceramic fiber comprising a plurality of crystallites, wherein at least 90% of the rare earth dopant is situated within said crystallites.

2. The glass-ceramic rare earth doped fiber according to claim 1, wherein said crystallites are 1000-nm or smaller.

3. The glass-ceramic rare earth doped fiber according to claim 1, wherein said crystallites are 100 nm or smaller.

4. The glass-ceramic rare earth doped fiber according to claim 1, wherein said crystallites are 10 nm or smaller.

5. The glass-ceramic rare earth doped fiber according to claim 1, wherein stimulated emission and absorption line shapes of said glass-ceramic rare earth doped fiber are narrower than that stimulated emission and absorption profile of a precursor rare earth doped glass.

6. The glass-ceramic according to claim 1 wherein said rare earth dopant is Pr, Er, Nd, Tm, or Dy, where dopant level is greater than 100 ppm.

7. An optical amplifier comprising:
(i) an input port;
(ii) a length of glass-ceramic rare earth doped fiber, said glass-ceramic fiber being operatively coupled to said input port; said glass-ceramic fiber including a plurality of crystallites, wherein at least 90% of said rare earth dopant is situated within said crystallites;
(iii) at least one of optical pump coupled to said glass-ceramic rare earth doped fiber;
(iv) an output port providing an amplified optical signal; and
(v) at least one optical component situated between said input port and said output port.

8. The optical amplifier according to claim 1, wherein said rare earth dopant is Pr, Nd, Tm, or Dy, Er.

9. The optical amplifier according to claim 7, wherein said crystallites are 1000 nm or smaller.

10. The optical amplifier according to claim 7, wherein said crystallites are 100 nm or smaller.

11. The optical amplifier according to claim 7, wherein at least 95% of said rare earth dopant is situated within said crystallites.

12. The optical amplifier according to claim 7, wherein essentially all rare earth dopant is the microcrystalline phase of said glass ceramic fiber, and essentially none of said rare earth dopant is present in a surrounding glass.

13. An amplifier according to claim 7, wherein said optical component is a filter, an optical attenuator, a multiplexer, or an isolator.

14. The optical amplifier according to claim 7, wherein stimulated emission profile of said glass ceramic fiber is narrower than that stimulated emission profile of the similarly rare-earth doped glass.

15. The optical amplifier according to claim 7, wherein stimulated emission profile of said glass ceramic fiber is narrower than that stimulated emission profile of a precursor rare earth doped glass.

16. The optical amplifier according to claim 7, wherein individual absorption peaks of the rare earth ions of said glass-ceramic fiber said amplifier providing gain in at least 1320 to 1360 nm range is narrower than that of the precursor rare earth doped glass.

17. The optical amplifier according to claim 7, wherein said rare earth dopant is Nd and said optical amplifier characterized by a shift in ESA spectrum in 1320 nm to 1360 nm wavelength range, with respect to emission.
